(19) United States
(12) Patent Application Publication
(10) Pub. No.: US 2016/0016824 A1
(43) Pub. Date: Jan. 21, 2016

(54) Grease Interceptor

(71) Applicant: Zurn Industries, LLC, Milwaukee, WI (US)

(72) Inventors: Matthew Dawes, Hilton, NY (US); Michael Henry, New Castle, PA (US)

(21) Appl. No.: 14/696,987

(22) Filed: Apr. 27, 2015

Related U.S. Application Data
(60) Provisional application No. 61/985,584, filed on Apr. 29, 2014.

(51) Int. Cl. C02F 1/40; E03F 5/16; B01D 17/02

(52) U.S. Cl. CPC C02F 1/40; B01D 17/0211; E03F 5/16; C02F 2101/32

(57) ABSTRACT

A grease interceptor includes a container having outer walls and a bottom connected to the outer walls, an inlet opening defined in one of the outer walls of the container, an outlet opening defined in an opposing outer wall of the container, an inlet baffle positioned adjacent the inlet opening, the inlet baffle comprising a protruding upper portion and a straight lower portion, a deflector positioned adjacent a bottom portion of the inlet baffle, a mid-wall baffle positioned at a substantially centered position along the longitudinal length of the container, and an exit baffle positioned adjacent the outlet opening. A method of removing grease from a wastewater stream through volume displacement is also disclosed.

### CROSS REFERENCE TO RELATED APPLICATION

This application claims the benefit of U.S. Provisional Application No. 61/985,584, filed Apr. 29, 2014, the disclosure of which is hereby incorporated by reference in its entirety.

### BACKGROUND OF THE INVENTION

1. Field of the Invention

The present invention relates to the treatment of wastewater products and, more particularly, to a grease interceptor designed for maximizing the disposal of grease, fats, and oils from wastewater.

2. Description of Related Art

Grease interceptors are typically installed at locations where grease is likely to be conveyed down a drain system with wastewater. To prevent an additional burden on the wastewater system, grease interceptors are installed between the point of water disposal and the wastewater system. Grease interceptors are typically installed at restaurants and food processing facilities due to the large amount of food that is prepared at each location. During the cleaning process, grease and other food particles may easily be washed away and deposited in the water system if a grease interceptor is not in place to mitigate the amount of contaminants that reach the water system. The overtaxing of municipal sewage treatment facilities has become a serious problem in many communities and ordinances requiring a reduction in volume of grease and insoluble solids discharged into municipal sewers are becoming more widespread and stringent.

When greasy wastewater is discharged through a wastewater disposal system, the grease accumulates on the interior walls of associated piping. As the grease coating grows, it obstructs the flow of wastewater in the sewage pipe. Grease interceptors are typically utilized to intercept and remove this grease prior to entrance into the disposal system. In many instances, grease interceptors are not properly cleaned or maintained which may result in inadequate removal of grease.

In an effort to improve the separation and collection of grease and foreign materials, grease interceptors may include a series of compartments. However, these compartmentalized grease interceptors typically utilize level and temperature sensors, valves, and heating devices to properly maintain the flow and separation of grease from the wastewater. Grease interceptors of this type require frequent cleaning to remove accumulated materials. Cleaning of these grease interceptors is an unpleasant task that can become very messy and tedious. However, if the grease interceptor is not properly maintained, the grease will collect on the sensors and valves, thereby causing the grease interceptor to function improperly. Therefore, there is a current need for a simple grease interceptor that minimizes the above-mentioned deficiencies due to improper cleaning and maintenance.

Grease interceptors are well known in the art for receiving and processing a mixture of water and grease. The water and grease mixture is introduced within the grease interceptor tank where a baffle obstructs the flow of the water and grease mixture causing the water and grease mixture to slow down in velocity. The grease interceptor includes a settling chamber, whereby the grease floats on top of the water and the water is removed from the bottom of the grease interceptor. In each grease interceptor design, a portion of the grease, or the solids, however small, will end up passing through the grease interceptor. Therefore, it is an object of the present invention to lower the amount of grease and/or solids that pass through the grease interceptor.

Grease interceptors, in principle, use the natural differences in buoyancy to remove contaminants such as fat, oil, and grease (FOG) from the types of wastewater experienced at restaurants or any location which processes or prepares food. The difference between the density of a contaminant and incoming water is the driving force behind separation. Having a larger difference in density between materials will result in faster separation. Other than differences in density between materials, there are other main parameters which affect the rate of rise of FOG. Droplet velocity, concentration, retention time, and the condition of the grease/oil as it enters the basin all contribute to the rate of separation.

Oils, having a noticeably lower density compared to water, will rise. Fats, having a density of 900 kg/m̂3 compared to water's average of 1000 kg/m̂3 at room temperature (20° C.), will also rise due to the difference in density but at a slower rate. Solid food and other particulates which also have the potential to enter the grease interceptor system will tend to either settle to the bottom of the interceptor or flow out with the filtered water. The settling of a particulate is dependent on the amount of time the particle is allowed to remain inside the interceptor.

The FOG particulates can also play a role in the rate of separation. Having a larger diameter grease globule will increase the rate of separation due to the increased difference in density from that of water. The relationship between the rate of rise and droplet size is directly proportional.

The velocity of the grease entering the interceptor can influence the rate of separation. Although interceptors are designed to slow all incoming wastewater to increase retention time, an increased velocity of a grease globule will allow the particle to more easily rise to the top of the interceptor. A slow or non-moving particle will not have enough momentum to drive itself upward and it will rely on differences in density alone, which can increase retention time. Increasing the vertical velocity and decreasing the horizontal velocity of grease entering the system can be important to a successful grease interceptor design.

The condition of the FOG entering the interceptor can also influence the rate of separation. With increased temperatures of FOG, these materials have a lower drag coefficient. In other words, the substances will have a decreased viscosity. With a lower viscosity, the contaminants have more ease rising to the top of the interceptor. A decreased temperature will increase the viscosity (drag coefficient) of a particle, thereby making the resistant forces for rising to the top to increase. This can also have a positive impact on the overall efficiency of the interceptor, however, due to the increased retention time seen with slower moving molecules entering the system.

With increased temperature, the solubility of grease also increases. With more grease dissolved within the wastewater, the particle size is significantly decreased, thus lowering the separation rate. Unless the mixture is allowed to cool to a lower temperature, the grease will not be separated and trapped by the interceptor.

The retention time is an important element when dealing with the rate of separation and having a successful interceptor. If the material entering the interceptor passes through too quickly, oil will not have enough time to rise to the top and materials with a lower specific volume and density will not have enough time to settle to the bottom of the basin. Retention time is calculated by dividing the volume of the interceptor by the flow rate. Therefore, there is a need for a grease interceptor that provides a flow through period equal to the retention time, meaning that in the amount of time it takes a particle to fully pass through the interceptor, it has also been retained and allowed to settle. Most current grease interceptors are made from a metallic material and periodically need to be replaced due to corrosion. The current grease interceptors can be very costly due to the use of stainless steel to avoid substantial corrosion. Therefore, it is an object of the present invention to provide a grease interceptor with a longer lifecycle, which will remain cost effective in the marketplace.

### SUMMARY OF THE INVENTION

In one embodiment, a grease interceptor includes a container having a plurality of outer walls and a bottom surface connected to the outer walls, an inlet opening defined in one of the outer walls of the container, an outlet opening defined in an opposing outer wall of the container, an inlet baffle positioned adjacent the inlet opening, the inlet baffle including a protruding upper portion and a straight lower portion, a deflector positioned adjacent a bottom portion of the inlet baffle, a mid-wall baffle positioned at a substantially centered position along the longitudinal length of the container, and an exit baffle positioned adjacent the outlet opening.

The inlet baffle, the deflector, the mid-wall baffle, and the exit baffle may be removably inserted into channels defined in the outer walls of the container. A top surface of the mid-wall baffle may be positioned closer to a top surface of the container than a top surface of the outlet opening. A lid may be removably attached to a top surface of the container. The lid may include at least one clip configured to hold the lid on the container. The container and lid may define at least one slot for receiving the at least one clip. The at least one clip may be snap-fit into place on the lid and the container. A top surface of the deflector may be positioned closer to a top surface of the container than a bottom surface of the inlet baffle. The inlet baffle may include an upper flange that extends outwardly from a top surface of the inlet baffle to rest on a top surface of the container. The protruding upper portion of the inlet baffle may be substantially bulbous shaped. A first separation chamber may be defined between the inlet baffle and the mid-wall baffle, and a second separation chamber may be defined between the mid-wall baffle and the exit baffle. The deflector, the mid-wall baffle, and the exit baffle may extend substantially perpendicular to the bottom surface of the container.

In another embodiment, a water containment device includes a container having a plurality of outer walls and a bottom surface connected to the outer walls, an inlet opening defined in one of the outer walls of the container, an outlet opening defined in an opposing outer wall of the container, a lid removably attached to a top surface of the container via at least one clip that is received in a channel defined by the lid and the container. The at least one clip may include a tab extending outwardly from the container. The tab may be configured to assist in snap-fitting the at least one clip onto the lid and container.

In another embodiment, a method of removing grease from a wastewater stream includes the steps of providing a grease interceptor including a container having outer walls and a bottom connected to the outer walls, an inlet opening defined in one of the outer walls of the container, an outlet opening defined in an opposing outer wall of the container, an inlet baffle positioned next to the inlet opening, and a deflector positioned near a bottom portion of the inlet baffle; directing wastewater filled with grease through the inlet opening and against a protruding portion of the inlet baffle, directing the wastewater out of a bottom end of the inlet baffle and against the deflector; directing the wastewater upwards in the container allowing grease to separate from the wastewater stream and float to a top surface of the container; and directing the wastewater out of the container through the outlet opening. The wastewater stream is directed through the outlet opening due to volume displacement within the container.

The method may also include the step of providing a mid-wall baffle between the inlet baffle and the outlet opening to define a first separation chamber and a second separation chamber in the container. The first separation chamber may be defined between the inlet baffle and the mid-wall baffle. The second separation chamber may be defined between the mid-wall baffle and the outlet opening. The method may also include the step of collecting a larger amount of grease in the first separation chamber than in the second separation chamber. The volume displacement within the container may be achieved by directing a substantially equal volume of clean water out of the container as compared to a volume of wastewater that is directed into the container. The method may further include the step of creating a turbulent flow in the wastewater when the wastewater is directed against the protruding portion of the inlet baffle. The method may further include the step of creating turbulent flow in and decreasing the velocity of the wastewater upon contacting the deflector. The method may further include the step of providing an exit baffle adjacent the outlet opening in the container to direct clean water out of the container.

Further details and advantages will be understood from the following detailed description read in conjunction with the accompanying drawings.

### BRIEF DESCRIPTION OF THE DRAWINGS

FIG. 1 is a top perspective view of a grease interceptor in accordance with this disclosure;

FIG. 2 is a top perspective view of the grease interceptor of FIG. 1 with a lid removed;

FIG. 3 is a top view of the grease interceptor of FIG. 1;

FIG. 4 is a side view of the grease interceptor of FIG. 1;

FIG. 5 is a back view of the grease interceptor of FIG. 1;

FIG. 6 is a top perspective view of the cover of the grease interceptor of FIG. 1;

FIG. 7 is a cross-sectional view of the grease interceptor of FIG. 1 showing the flow path of wastewater through the grease interceptor;

FIG. 8 is a top perspective, cross-sectional view of the grease interceptor of FIG. 1;

FIG. 9 is a front perspective view of a baffle insert used with the grease interceptor of FIG. 1;

FIG. 10 is a top view of the baffle insert of FIG. 9;

FIG. 11 is a side view of the baffle insert of FIG. 9;

FIG. 12 is a back view of the baffle insert of FIG. 9;

FIG. 13 is a front perspective view of a cover clip used with the grease interceptor of FIG. 1; and

FIG. 14 is a side view of the cover clip of FIG. 13.

### DETAILED DESCRIPTION OF THE PREFERRED EMBODIMENTS

For purposes of the description hereinafter, spatial orientation terms, as used, shall relate to the referenced embodiment as it is oriented in the accompanying drawings, figures, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply exemplary and should not be considered as limiting.

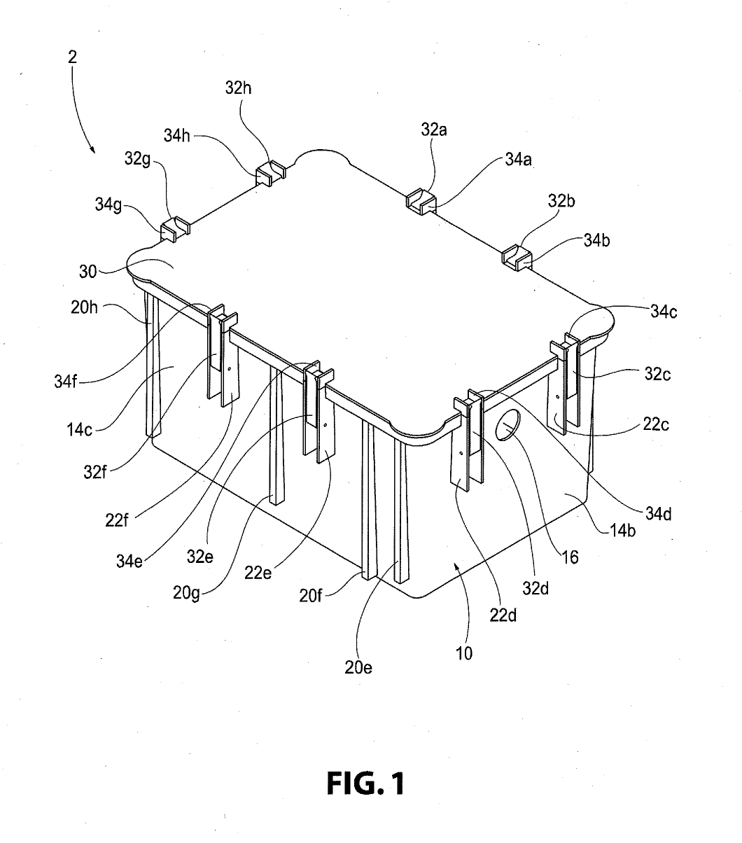

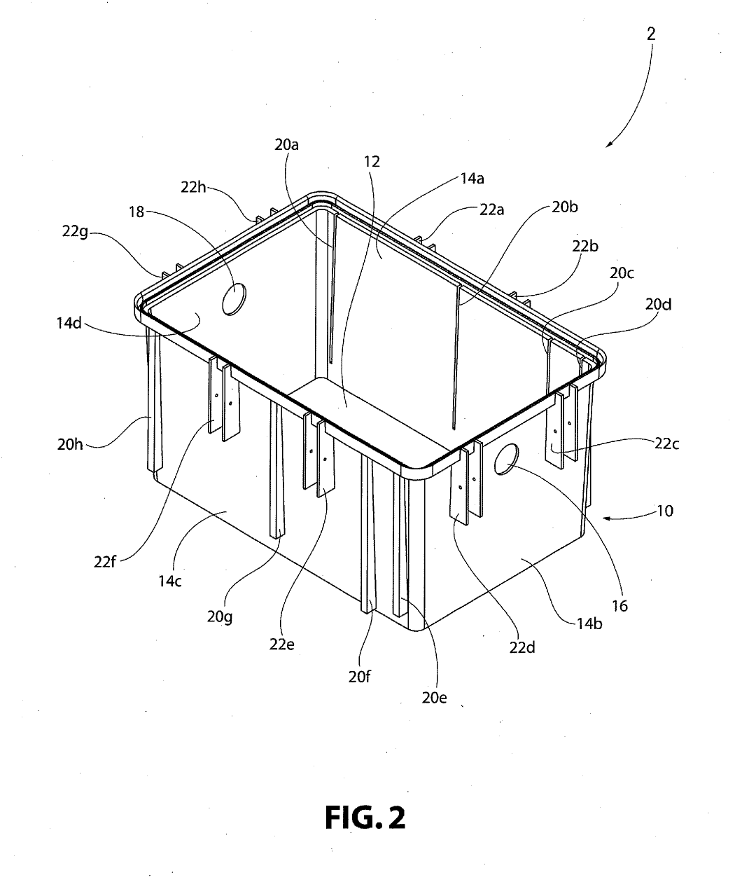

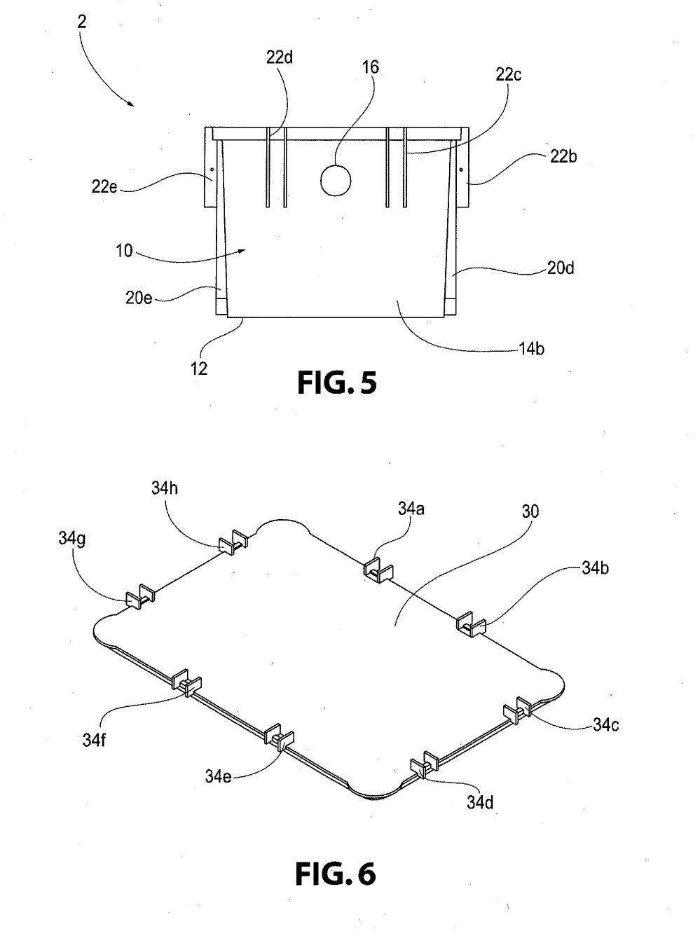

Referring to FIGS. 1, 2, 4, and 5, a grease interceptor 2 is described in detail. The grease interceptor 2 includes a container 10 having a bottom 12 and four walls 14a, 14b, 14c, and 14d extending upward from the bottom 12. In one embodiment, the container 10 is rectangular-shaped. It is to be understood, however, that additional shapes and sizes of the container 10 are contemplated, such as square-shaped. The grease interceptor 2 may be made from a plastic material such as polyethylene or polypropylene. Alternative materials may also be used such as a metal or a hard rubber. An inlet opening 16 is defined in one wall 14b of the container 10 and establishes fluid communication between the container 10 and a drain outlet (not shown). The diameter of the inlet opening 16 may correspond to the diameter of the drain outlet. An outlet opening 18 is defined in an opposing wall 14d of the container 10 and establishes fluid communication between the container 10 and a wastewater treatment system (not shown). The diameter of the outlet opening 18 may correspond to the diameter of the piping leading to the wastewater treatment system. The outlet opening 18 may be positioned in closer proximity to the top of the container 10 than the bottom of the container 10.

A plurality of channels 20a-20h are also defined in an inner surface of the walls 14a, 14c of the container 10. The channels 20a-20h extend from an upper portion of the walls 14a, 14c to a bottom portion of the walls 14a, 14c. As shown in FIG. 4, at least one of the channels 20f may extend closer to the bottom surface of the container 10 than other channels 20e, 20g, 20h. The channels 20a-20h are configured to receive additional components of the grease interceptor 2 as will be discussed in further detail below. A plurality of slots 22a-22h are positioned at an upper portion of an outer surface of the walls 14a-14d of the container 10. In one embodiment, there are two slots 22a-22h positioned on each wall 14a-14d. The slots 22a-22h include two vertical members that define a channel therebetween. It is contemplated that more or fewer slots may be provided on the container 10.

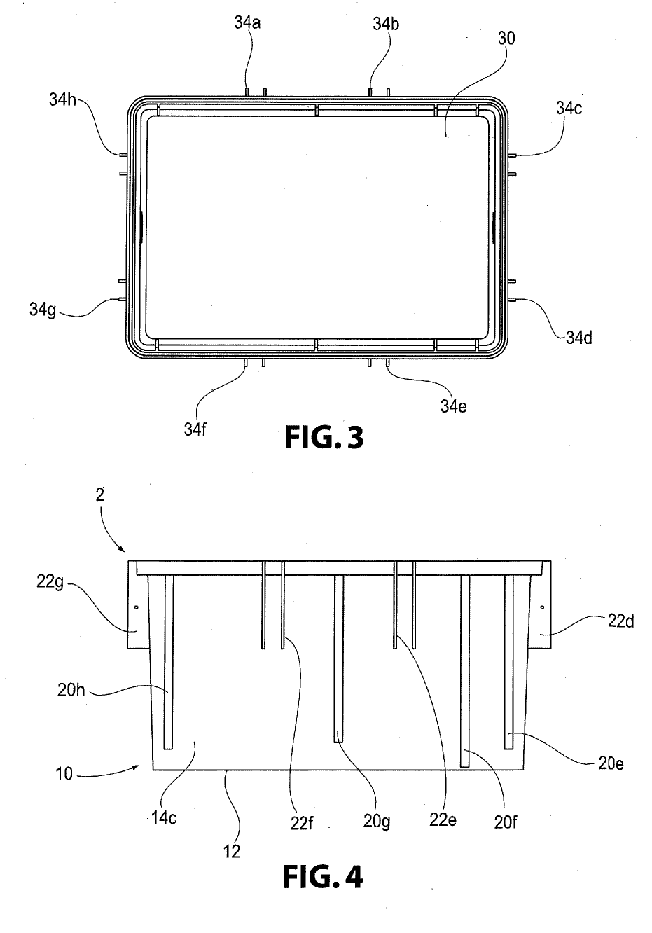

As shown in FIGS. 1, 3, and 6, the grease interceptor 2 also includes a lid 30 for sealing the top of the grease interceptor 2. The upper surface of the container 10 may include a recessed ledge to allow the lid 30 to rest thereon. The lid 30 corresponds to the shape of the container 10, so that upon placement of the lid 30 on top of the container 10 an air-tight seal is established. It is also contemplated that a lid 30 may not be used with the grease interceptor 2. The lid 30 includes a plurality of slots 34a-34h positioned on a top surface of the lid 30. The slots 34a-34h are positioned on the lid 30 to correspond to the position of the slots 22a-22h on the container 10 when the lid 30 is provided on the container 10. When the slots 34a-34h of the lid 30 align with the slots 22a-22h of the container 10, an elongated channel is established therebetween. This elongated channel is longer in length than each of the channels defined by each individual, slot 22a-22h, 34a-34h. These elongated channels established by the slots 22a-22h of the container 10 and the slots 34a-34h of the lid 30 are configured to receive a plurality of cover clips 32a-32h. The cover clips 32a-32h are inserted into the elongated channels defined by the slots 22a-22h of the container 10 and the slots 34a-34h of the lid 30. The cover clips 32a-32h may be configured to lock the lid 30 onto the container 10. In one embodiment, the cover clips 32a-32h may be snap-fit into the elongated channels defined by the lid 30 and container 10. It is also contemplated that the cover clips 32a-32h may be mechanically fastened to the lid 30 and the container 10 using screws, nails, or other suitable fasteners. The lid 30 may also be locked on the container 10 using a friction fit, adhesive, or a hinged arrangement. In another embodiment, the lid 30 may be integrally formed with the container 10, thereby creating a single, monolithic structure. However, since the lid 30 could not be removed to clean the container 10, this is not a preferred embodiment. By using the cover clips 32a-32h to hold the container 10 and the lid 30 together, an air-tight seal is formed therebetween. This air tight seal may assist in preventing wastewater and grease from spilling out of the container 10, as well as blocking unpleasant odors from leaking out of the container 10.

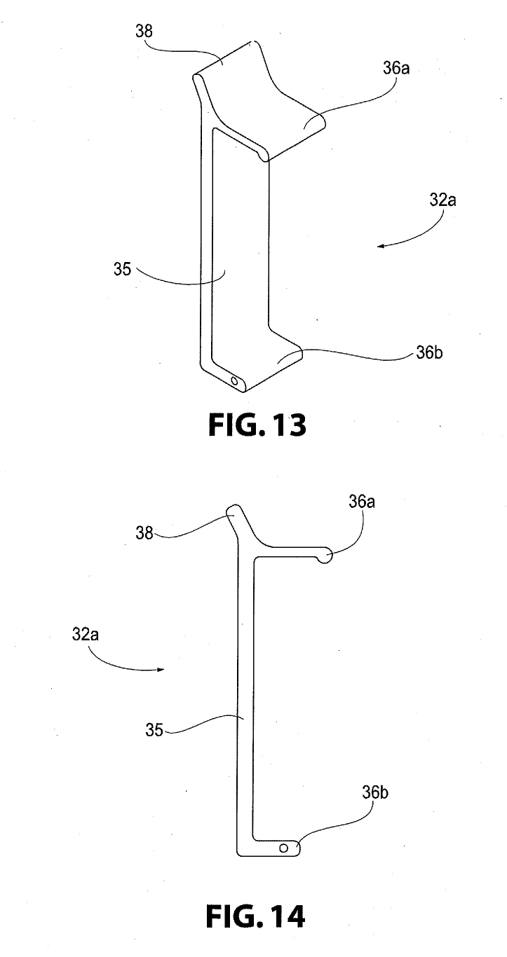

As shown in FIGS. 13 and 14, each cover clip 32a-32h is substantially U-shaped with a pair of horizontal members 36a, 36b extending from a vertical member 35. An extension member 38 extends in an opposing direction from the top horizontal member 36a. The extension member 38 is configured to permit an individual to apply pressure to each cover clip 32a-32h to snap-fit the cover clips 32a-32h on and off of the container 10 and the lid 30. The cover clips 32a-32h may be separate and removable from the lid 30 and container 10. Alternatively, the cover clips 32a-32h may be hingedly connected to the container 10 via the lower horizontal member 36b or to the lid 30 via the top horizontal member 36a.

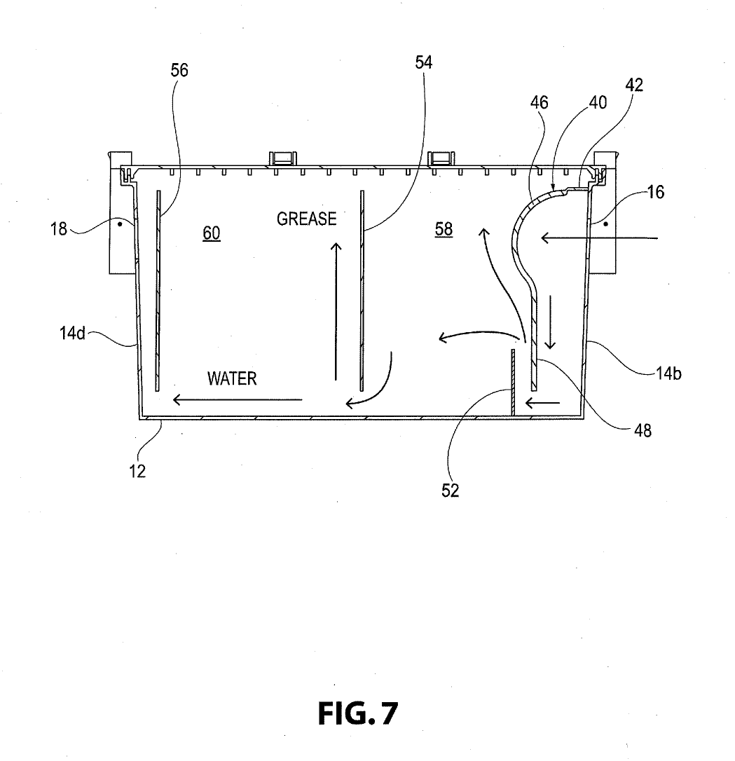

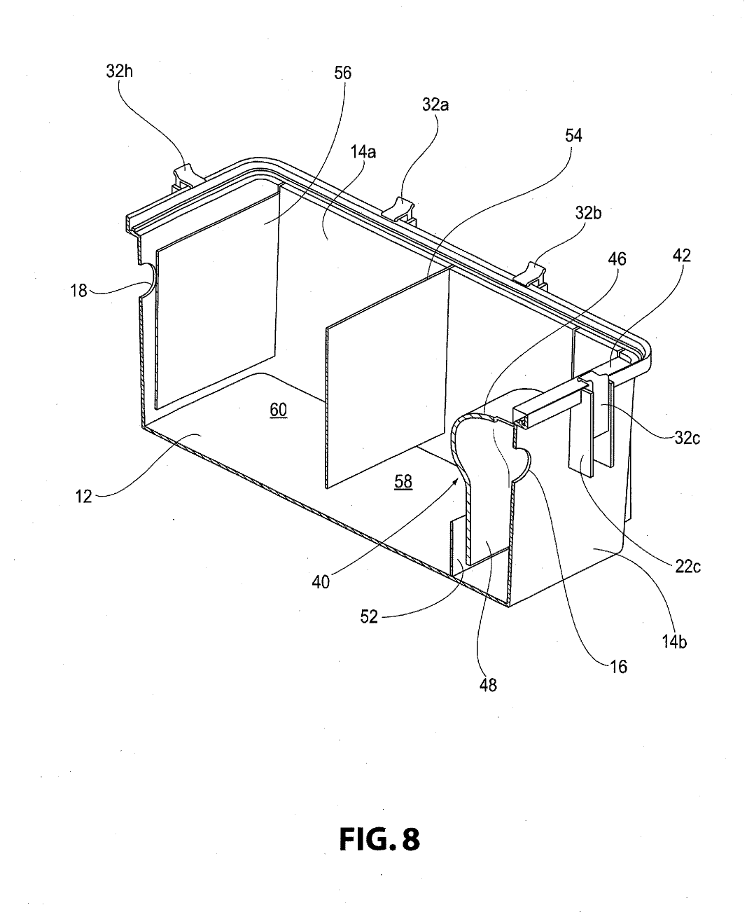

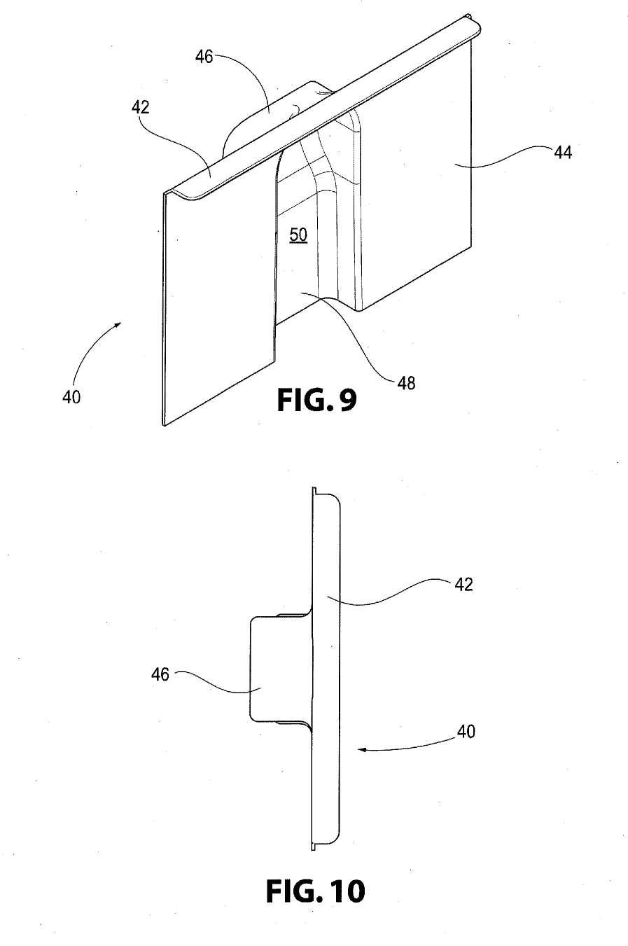

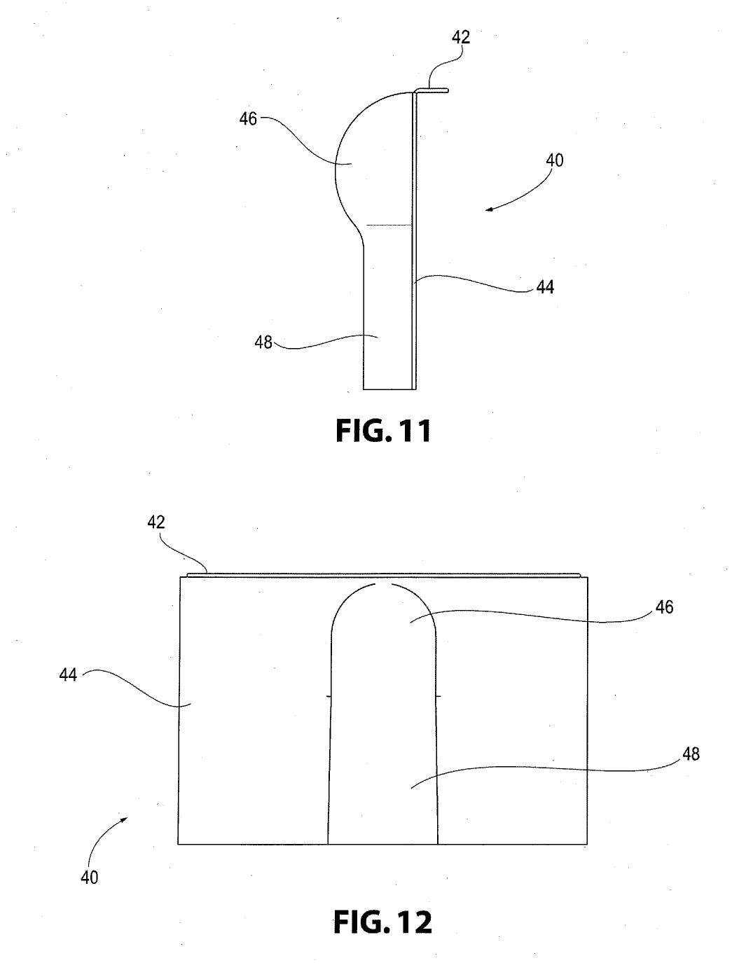

As shown in FIGS. 7-12, an inlet baffle 40 extends across the width of the container 10 and is positioned near the inlet opening 16. The inlet baffle 40 slides into the channels 20d, 20e of the container 10 to rigidly hold the inlet baffle 40 within the container 10. This allows for easy removal of the inlet baffle 40 to clean the inlet baffle 40 or the container 10. It is also contemplated that the inlet baffle 40 may be integrally formed with the container 10. The inlet baffle 40 includes an upper flange 42, a lower flange 44, a protruding portion 46, and a straight portion 48. The protruding portion 46 extends upward and outward from the straight portion 48. The protruding portion 46 has a substantially bulbous shape. In one embodiment, a bulbous shape may include a round and elongated shape. However, it is to be understood that the protruding portion 46 may have any alternative shape that directs wastewater into the container 10. The lower flange 44 extends laterally from a front surface of the protruding portion 46 and the straight portion 48. The lower flange 44 is inserted into the channels 20d, 20e defined in the container 10, thereby holding the inlet baffle 40 in the container 10. The upper flange 42 extends outwardly from a top surface of the lower flange 44. The upper flange 42 is configured to abut an upper portion of the container 10 above the inlet opening 16. The protruding portion 46 and the straight portion 48 of the inlet baffle 40 define a channel 50 therebetween that directs wastewater from the inlet opening 16 to the bottom of the container 10.

The container 10 also includes a deflector 52 positioned on a bottom surface of the container 10 near the bottom portion of the inlet baffle 40. The deflector 52 extends across the bottom width of the container 10 and is inserted into the channels 20c, 20f of the container 10. The deflector 52 may also be integrally formed with the container 10. A top surface of the deflector 52 is positioned above the bottom surface of the inlet baffle 40. The deflector 52 may be configured to direct any wastewater that exits out of the bottom portion of the inlet baffle 40 upwardly within the container 10.

A mid-wall baffle 54 is positioned in the center portion of the container 10 between the inlet opening 16 and the outlet opening 18. The mid-wall baffle 54 slides into the channels 20b, 20g of the container 10. The mid-wall baffle 54 may also be intergrally formed with the container 10. The mid-wall baffle 54 does not extend to the bottom surface of the container 10 nor does the mid-wall baffle 54 extend to the top surface of the container 10. Using this arrangement, wastewater may flow underneath of the mid-wall baffle 54. The mid-wall baffle 54 extends across the width of the container 10.

An exit baffle 56 is positioned near the outlet opening 18 in the container 10. The exit baffle 56 slides in to the channels 20a, 20h of the container 10. The exit baffle 56 may also be integrally formed with the container 10. Similar to the mid-wall baffle 54, the exit baffle 56 does not extend to the bottom surface of the container 10 nor does the exit baffle 56 extend to the top surface of the container 10. The inlet baffle 40, the deflector 52, the mid-wall baffle 54, and the exit baffle 56 are removably inserted into the channels 20a-20h to allow an individual to remove them for cleaning and emptying the container 10 of any grease or food particles deposited therein. The inlet baffle 40, the deflector 52, the mid-wall baffle 54, and the exit baffle 56 may be snap-fit or friction fit into the channels 20a-20h of the container 10. A first separation chamber 58 is defined between the inlet baffle 40 and the mid-wall baffle 54. A second separation chamber 60 is defined between the mid-wall baffle 54 and the exit baffle 56.

With reference to FIG. 7, operation of the grease interceptor 2 will now be described. Wastewater that enters the grease interceptor 2 through the inlet opening 16 is directed against the protruding portion 46 of the inlet baffle 40. As the wastewater is directed against the inlet baffle 40, the wastewater loses its horizontal velocity component and is directed downwardly towards the bottom of the container 10. The wastewater may develop a turbulent flow in the protruding portion 46 as the wastewater deflects in several different directions upon contacting the protruding portion 46. This turbulent flow will assist in separating the grease from the water in the wastewater. Air may also be entrained in the wastewater stream due to the turbulent wastewater flow that is created inside of the protruding portion 46 of the inlet baffle 40, wherein air bubbles may adhere to the outer surface of any grease globules in the wastewater stream. By adhering air bubbles to the grease globules, the air bubbles can assist the grease globules in floating to the top of the grease interceptor 2. The wastewater is directed out of the protruding portion 46 and through the channel 50 defined in the inlet baffle 40, eventually exiting out of the bottom portion of the inlet baffle 40.

Once the wastewater travels under the bottom surface of the inlet baffle 40, the wastewater is directed against the deflector 52. The deflector 52 may create additional turbulent flow in the wastewater to further separate the grease from the water. The deflector 52 will also assist in reducing the velocity of the wastewater. The deflector 52 directs the wastewater upwardly towards the upper portion of the container 10. At this point, any heavy solid food particles in the wastewater stream have already been filtered from the wastewater stream at a point upstream of the grease interceptor 2 using a filtering arrangement (not shown). Therefore, the wastewater stream will most likely only contain grease, oil, and fat particles. However, if any heavy solid food particles were to remain in the wastewater stream in the grease interceptor 2, the heavy solid food particles would fall to the bottom surface of the container 10 next to the deflector 52. The trapped food particles can be easily removed from the container 10 by removing the lid 30 and scooping out the food particles from the container 10.

As the wastewater is directed upward in the container 10, the grease in the relatively slow wastewater stream has an opportunity to float to the top surface of the water held in the container 10, thereby forming a grease layer on the top of the water. Due to the slow velocity of the wastewater and the differences in density of the grease and water, the grease can separate from the water and float to the top surface of the container 10. The wastewater may be slowed to a velocity that maximizes the retention time of the wastewater in the separation chambers 58, 60, without completely stopping the flow of wastewater through the container 10. It should be appreciated that during operation of the grease interceptor 2, the level of wastewater within the grease interceptor 2 may not be lower than the lower ends of the inlet opening 16 and the outlet opening 18. A substantial portion of the grease is separated from the wastewater stream in the first separation chamber 58 of the container 10. However, additional grease may be separated from the water in the second separation chamber 60, as well.

After the first separation stage, the wastewater stream is directed underneath the mid-wall baffle 54 into the second separation chamber 60. Heavy food particles still left in the wastewater stream may drop to the bottom surface of the container 10 at this point also. As the wastewater stream continues to lose velocity, the remaining grease in the wastewater stream has an opportunity to float to the top surface of the water in the container 10. The clean wastewater stream is then directed underneath the bottom surface of the exit baffle 56 and out of the outlet opening 18. Clean wastewater is removed from the grease interceptor 2 through volume displacement within the container 10. Using this volume displacement arrangement, as new wastewater is directed into the container 10 through the inlet opening 16, clean water positioned near the outlet opening 18 of the container 10 is pushed out of the grease interceptor 2. Therefore, clean water is not removed from the grease interceptor 2 until new wastewater is directed into the grease interceptor 2 and pushes the clean wastewater out of the grease interceptor 2. The volume of clean water that is directed out of the outlet opening 18 may be substantially equal to the volume of wastewater that is directed into the inlet opening 16. Further, since the outlet opening 18 is positioned lower than the top of the mid-wall baffle 54 in the container 10, any water will drain out of the outlet opening 18 before flowing over the mid-wall baffle 54. Using this arrangement, all of the grease collected on the top surface in the first separation chamber 58 cannot overflow into the cleaner water in the second separation chamber 60.

While an embodiment of a grease interceptor is shown in the accompanying figures and described hereinabove in detail, other embodiments will be readily apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A grease interceptor, comprising:
a container having a plurality of outer walls and a bottom surface connected to the outer walls;
an inlet opening defined in one of the outer walls of the container;
an outlet opening defined in an opposing outer wall of the container;
an inlet baffle positioned adjacent the inlet opening, the inlet baffle comprising a protruding upper portion and a straight lower portion;
a deflector positioned adjacent a bottom portion of the inlet baffle;
a mid-wall baffle positioned at a substantially centered position along the longitudinal length of the container;
and an exit baffle positioned adjacent the outlet opening.

2. The grease interceptor as claimed in claim 1, wherein the inlet baffle, the deflector, the mid-wall baffle, and the exit baffle are removably inserted into channels defined in the outer walls of the container.

3. The grease interceptor as claimed in claim 1, wherein a top surface of the mid-wall baffle is positioned closer to a top surface of the container than a top surface of the outlet opening.

4. The grease interceptor as claimed in claim 1, further comprising a lid removably attached to a top surface of the container.

5. The grease interceptor as claimed in claim 4, wherein the lid comprises at least one clip configured to hold the lid on the container.

6. The grease interceptor as claimed in claim 5, wherein the container and lid define at least one slot for receiving the at least one clip.

7. The grease interceptor as claimed in claim 6, wherein the at least one clip is snap-fit into place on the lid and the container.

8. The grease interceptor as claimed in claim 1, wherein a top surface of the deflector is positioned closer to a top surface of the container than a bottom surface of the inlet baffle.

9. The grease interceptor as claimed in claim 1, wherein the inlet baffle further comprises an upper flange that extends outwardly from a top surface of the inlet baffle to rest on a top surface of the container.

10. The grease interceptor as claimed in claim 1, wherein the protruding upper portion of the inlet baffle is substantially bulbous shaped.

11. The grease interceptor as claimed in claim 1, wherein a first separation chamber is defined between the inlet baffle and the mid-wall baffle, and a second separation chamber is defined between the mid-wall baffle and the exit baffle.

12. The grease interceptor as claimed in claim 1, wherein the deflector, the mid-wall baffle, and the exit baffle extend substantially perpendicular to the bottom surface of the container.

13. A water containment device, comprising:
a container having a plurality of outer walls and a bottom surface connected to the outer walls;
an inlet opening defined in one of the outer walls of the container;
an outlet opening defined in an opposing outer wall of the container;
a lid removably attached to a top surface of the container via at least one clip that is received in a channel defined by the lid and the container.

14. The water containment device as claimed in claim 13, wherein the at least one clip comprises a tab extending outwardly from the container, wherein the tab is configured to assist in snap-fitting the at least one clip onto the lid and container.

15. A method of removing grease from a wastewater stream, comprising the steps of:
a) providing a grease interceptor comprising a container having outer walls and a bottom connected to the outer walls, an inlet opening defined in one of the outer walls of the container, an outlet opening defined in an opposing outer wall of the container, an inlet baffle positioned next to the inlet opening, and a deflector positioned near a bottom portion of the inlet baffle;
b) directing wastewater filled with grease through the inlet opening and against a protruding portion of the inlet baffle;
c) directing the wastewater out of a bottom end of the inlet baffle and against the deflector;
d) directing the wastewater upwards in the container allowing grease to separate from the wastewater stream and float to a top surface of the container; and
e) directing the wastewater out of the container through the outlet opening,
wherein the wastewater stream is directed through the outlet opening due to volume displacement within the container.

16. The method of removing grease from a wastewater stream as claimed in claim 15, further comprising the steps of:
providing a mid-wall baffle between the inlet baffle and the outlet opening to define a first separation chamber and a second separation chamber in the container, wherein the first separation chamber is defined between the inlet baffle and the mid-wall baffle, and wherein the second separation chamber is defined between the mid-wall baffle and the outlet opening; and
collecting a larger amount of grease in the first separation chamber than in the second separation chamber.

17. The method of removing grease from a wastewater stream as claimed in claim 15, wherein the volume displacement within the container is achieved by directing a substantially equal volume of clean water out of the container as compared to a volume of wastewater that is directed into the container.

18. The method of removing grease from a wastewater stream as claimed in claim 15, further comprising the step of creating a turbulent flow in the wastewater when the wastewater is directed against the protruding portion of the inlet baffle.

19. The method of removing grease from a wastewater stream as claimed in claim 15, further comprising the step of creating turbulent flow in and decreasing the velocity of the wastewater upon contacting the deflector.

20. The method of removing grease from a wastewater stream as claimed in claim 15, further comprising the step of providing an exit baffle adjacent the outlet opening in the container to direct clean water out of the container.
